(19) United States
(12) Patent Application Publication
(10) Pub. No.: US 2006/0132041 A1
(43) Pub. Date: Jun. 22, 2006

(54) External electrode fluorescent lamp and method of fabricating the same

(75) Inventor: Jong-Hyun Choi, Incheon (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/151,336

(22) Filed: Jun. 13, 2005

(30) Foreign Application Priority Data
Dec. 17, 2004 (KR) 2004-0108159

(51) Int. Cl. H01J 65/00; H01J 61/06; H01J 11/00

(52) U.S. Cl. 313/607

(57) ABSTRACT

An external electrode fluorescent lamp is provided that includes a tube having electrode regions at end regions and a fluorescent region between the end regions. A phosphor layer is formed by dipping an open end of the tube into a solution containing phosphor material and permitting a capillary phenomenon to deposit the phosphor material on the inner surface of the tube in the corresponding electrode region and the fluorescent region. The phosphor material is then baked and the baked phosphor material in the electrode region is removed. A protection material is deposited on the phosphor layer and the inner surface of the tube and then baked to form a protection layer. One end is closed, a discharge gas filled in an inner space of the tube and the other end is then closed. External electrodes are then disposed on an outer surface of the tube in the electrode regions.

The present invention claims the benefit of Korean Patent Application No. 2004-0108159, filed in Korea on Dec. 17, 2004, which is hereby incorporated by reference.

### FIELD OF THE INVENTION

The present invention relates to a fluorescent lamp, and more particularly, to an external electrode fluorescent lamp (EEFL) and a method of fabricating the same.

### DISCUSSION OF THE RELATED ART

Until recently, display devices have generally used a cathode-ray tube (CRT). Presently, much effort is being expended to study and develop various types of flat panel displays (FPDs), such as a liquid crystal display (LCD) device, a plasma display panel (PDP), a field emission display (FED), and an electro-luminescence display (ELD), as a substitute for CRTs. These FPDs are categorized into luminous types such as the PDP, FED and ELD that do not use a backlight, and non-luminous types such as the LCD that use a backlight.

The backlight of the non-luminous type FPD uses various types of lamps, such as a cold cathode fluorescent lamp (CCFL), an external electrode fluorescent lamp (EEFL) and a non-electrode type fluorescent lamp. The CCFL has electrodes inside both end portions of the CCFL, the EEFL has electrodes outside both end portions of the EEFL, and the non-electrode type fluorescent lamp does not have electrodes. Of these lamps, the EEFL has advantages, such as long lifetime.

FIG. 1 is a schematic plan view illustrating an EEFL according to the related art.

As shown in FIG. 1, an EEFL includes a glass tube 11 having openings at both ends of the glass tube 11, and two external electrodes 13 at both end regions to cover the openings. The glass tube 11 is filled with a discharge gas including an inert gas and mercury (Hg). The external electrode 13 is made of a conductive material, and has a cap shape covering the opening. On an inner surface of the glass tube 11, a phosphor layer and a protection layer are formed.

FIG. 2 is a flow chart illustrating a method of fabricating an EEFL according to the related art.

As shown in FIG. 2, with a first step (ST1), a glass tube 11 (of FIG. 1) is prepared. The glass tube has two openings at both ends thereof.

Subsequently, with a second step (ST2), a protection layer is formed on an inner surface of the glass tube.

Subsequently, with a third step (ST3), a baking process is conducted for the protection layer.

Subsequently, with a fourth step (ST4), a phosphor layer is formed on the protecting layer.

Subsequently, with a fifth step (ST5), a vacuum process and a baking process are conducted sequentially for the phosphor layer, and thus impurities are removed.

Subsequently, with a sixth process (ST6), portions of the phosphor layer in both end regions, where two external electrodes 13 (of FIG. 1) are formed with a next process, are removed. If the phosphor layer is formed at the end regions where the external electrodes are formed, ions and electrons accelerated due to high voltages in the end regions causes deterioration of the phosphor layer. Accordingly, the portions of the phosphor layer corresponding to the external electrodes are removed. As the phosphor layer deteriorates, the color of the phosphor layer is changed to yellow.

Subsequently, with a seventh step (ST7), a discharge gas is injected and the openings are closed. In more detail, one opening is closed under vacuum, a discharge gas is injected to fill an inner space of the glass tube, and then the other opening is closed.

Subsequently, with an eighth step (ST8), two external electrodes are formed.

As explained above, the phosphor layer is formed immediately after the protection layer is formed. Accordingly, when the portions of the phosphor layer in the end regions, where the external electrodes are formed, are removed, the portions of the protection layer in the end regions also are removed. Since plasma in the end regions has a high density, the accelerated ions and electrons in the plasma cause damage to the glass tube in the end regions. This reduces the lifetime of the EEFL, and thus degrades the EEFL reliability.

### SUMMARY OF THE INVENTION

By way of introduction only, in one aspect an external electrode fluorescent lamp comprises a tube having an electrode region at end regions and a fluorescent region between the end regions. A discharge gas fills an inner space of the tube. A phosphor layer contacts an inner surface of the tube in the fluorescent region. A protection layer covers the phosphor layer. External electrodes are disposed on an outer surface of the tube in the electrode regions.

In anther aspect, a method of fabricating an external electrode fluorescent lamp comprising: preparing a tube having openings at ends of the tube, the tube having electrode regions at end regions and a fluorescent region between the end regions; forming a phosphor layer on an inner surface of the tube in the fluorescent region such that the phosphor layer contacts the inner surface of the tube in the fluorescent region; forming a protection layer covering the phosphor layer; filling an inner space of the tube with a discharge gas and closing the openings; and forming external electrodes on an outer surface of the tube in the electrode regions. The phosphor layer is formed by dipping an open end of the tube into the phosphor material solution, thereby depositing the phosphor material on the inner surface of the tube in the corresponding electrode region and the fluorescent region through a capillary phenomenon; baking the phosphor material; and removing the baked phosphor material in the electrode region to form the phosphor layer. The protection layer is formed by depositing a protection material on the phosphor layer and the inner surface of the tube; and baking the protection material to form the protection layer.

In another aspect, a method of fabricating an external electrode fluorescent lamp comprises: forming a phosphor layer directly on an inner surface of a tube in the fluorescent region from an electrode region of the tube to substantially an opposing electrode region of the tube and removing the phosphor layer from the one electrode region; forming a protection layer covering the phosphor layer; filling an inner space of the tube with a discharge gas and closing openings of the tube; and forming external electrodes on an outer surface of the tube in the electrode regions.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a schematic plan view illustrating an EEFL according to the related art;

FIG. 2 is a flow chart illustrating a method of fabricating an EEFL according to the related art;

FIG. 3A is a cross-sectional view illustrating a process of preparing a tube for an EEFL according to the exemplary embodiment of the present invention;

FIG. 3B is a cross-sectional view illustrating a process of forming a phosphor layer of an EEFL according to the exemplary embodiment of the present invention;

FIG. 3C is a cross-sectional view illustrating a process of baking the phosphor layer of an EEFL according to the exemplary embodiment of the present invention

FIG. 3D is a cross-sectional view illustrating a process of removing a portion of phosphor layer in the first electrode region of an EEFL according to the exemplary embodiment of the present invention;

FIG. 3E is a cross-sectional view illustrating a process of forming a protection layer of an EEFL according to the exemplary embodiment of the present invention;

FIG. 3F is a cross-sectional view illustrating a process of baking the protection layer of an EEFL according to the exemplary embodiment of the present invention;

FIG. 3G is a cross-sectional view illustrating processes of injecting a discharge gas and closing the first and second openings of an EEFL according to the exemplary embodiment of the present invention; and

FIG. 3H is a cross-sectional view illustrating a process of forming first and second external electrodes of an EEFL according to the exemplary embodiment of the present invention.

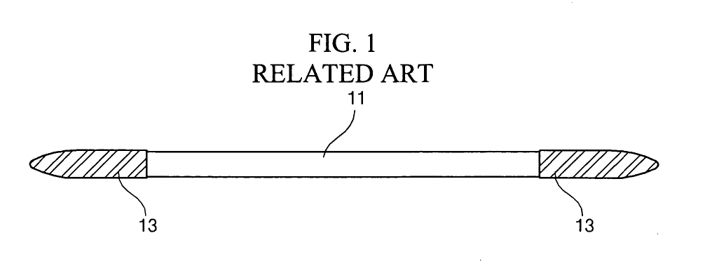

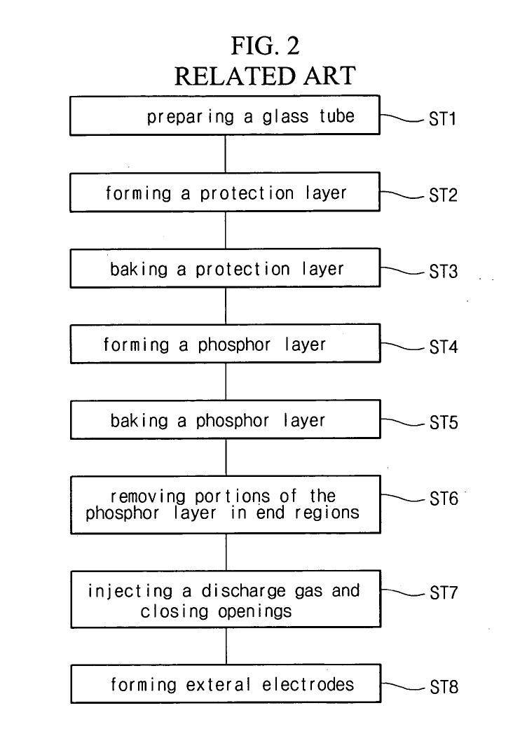

### DETAILED DESCRIPTION OF THE PREFERRED EMBODIMENTS

Reference will now be made in detail to the illustrated embodiments of the present invention, which are illustrated in the accompanying drawings.

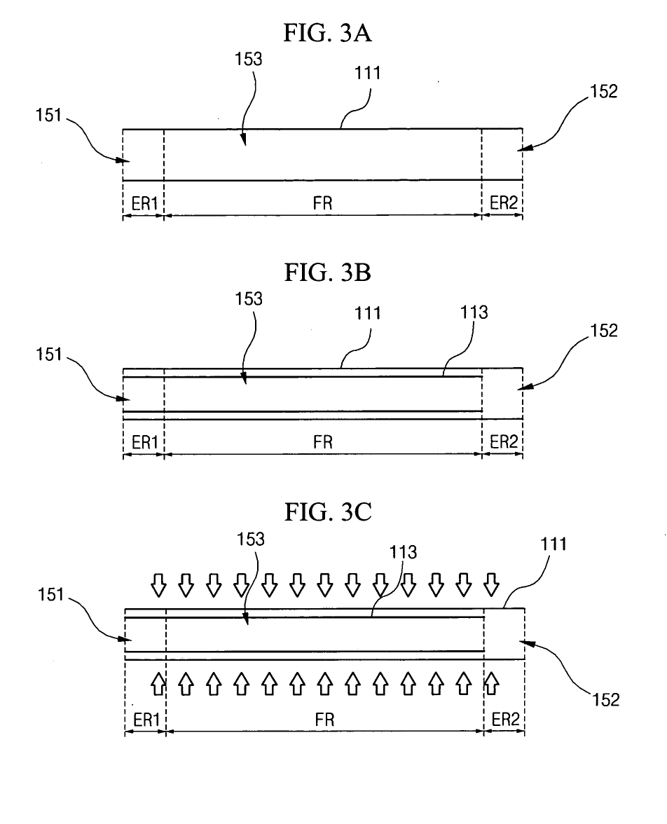

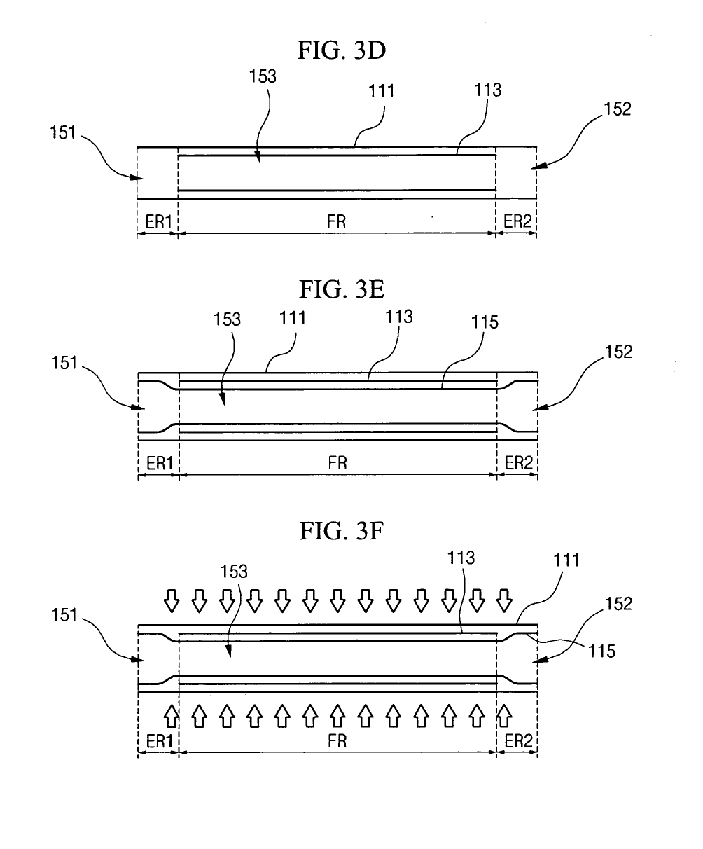

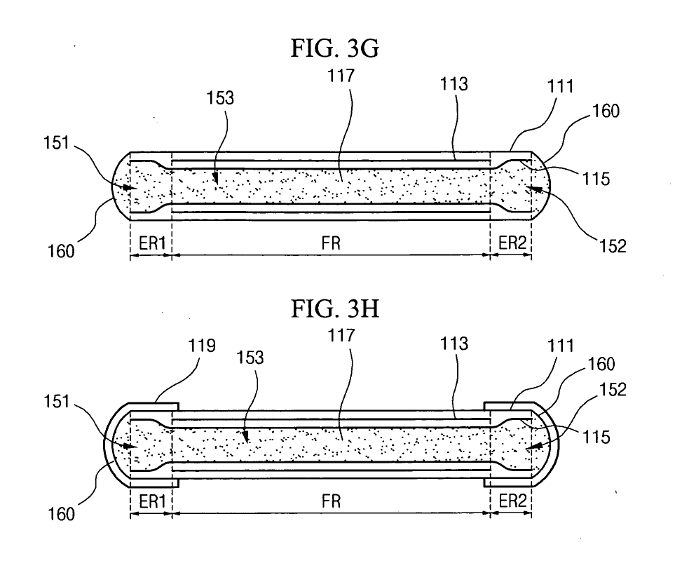

FIGS. 3A and 3H are cross-sectional views illustrating a method of fabricating EEFL according to an exemplary embodiment of the present invention.

FIG. 3A is a cross-sectional view illustrating a process of preparing a tube for an EEFL according to the exemplary embodiment of the present invention.

As shown in FIG. 3A, an insulating tube 111 such as a glass tube is prepared. The tube 111 is extended along one direction, and has first and second openings 151 and 152 at both ends of the tube 111. Accordingly, an inner space 153 of the tube 111 is open to an exterior. First and second electrode regions “ER1” and “ER2” are defined at both end regions, and a fluorescent region “FR” is defined between the first and second electrode regions “ER1” and “ER2”.

FIG. 3B is a cross-sectional view illustrating a process of forming a phosphor layer of an EEFL according to the exemplary embodiment of the present invention.

As shown in FIG. 3B, a phosphor material is deposited on an inner surface of the tube 111 to form a phosphor layer 113. To form the phosphor layer 113, a capillary phenomenon may be used. For example, the first opening 151 of the tube 111 is dipped into a liquid solution of the phosphor material such that the phosphor material rises along the inner surface of the tube 111 due to the capillary phenomenon. In particular, the tube 111 is dipped such that the phosphor material is deposited in the first electrode region “ER1” and the fluorescent region “FR” not the second electrode region “ER2”.

FIG. 3C is a cross-sectional view illustrating a process of baking the phosphor layer of an EEFL according to the exemplary embodiment of the present invention.

As shown in FIG. 3C, a baking process by using a high current and a high voltage is conducted for the liquid phosphor layer 113 under vacuum. Accordingly, the phosphor layer 113 adheres closely to the inner surface of the tube 111 and cured. Further, impurities in the tube 111 are removed away and vacuum level is improved.

FIG. 3D is a cross-sectional view illustrating a process of removing a portion of phosphor layer in the first electrode region of an EEFL according to the exemplary embodiment of the present invention.

As shown in FIG. 3D, the portion of the phosphor layer 113 in the first electrode region “ER I” is removed by using a brush.

FIG. 3E is a cross-sectional view illustrating a process of forming a protection layer of an EEFL according to the exemplary embodiment of the present invention.

As shown in FIG. 3E, a protection material is deposited on the entire inner surface of the tube 111 having the phosphor layer 113 to form a protection layer 115.

FIG. 3F is a cross-sectional view illustrating a process of baking the protection layer of an EEFL according to the exemplary embodiment of the present invention.

As shown in FIG. 3F, a baking process is conducted for the liquid protection layer 115. Through the baking process, impurities in the protection layer 115 are removed, and the liquid protection layer 115 is cured. Subsequently, ventilating process is conducted for removing the impurities and residual gases in the inner space 153.

FIG. 3G is a cross-sectional view illustrating processes of injecting a discharge gas and closing the first and second openings of an EEFL according to the exemplary embodiment of the present invention.

As shown in FIG. 3G, a discharge gas 117 is injected and the openings 151 and 152 are closed. In more detail, one of the first and second openings 151 and 152 is closed with a closing means 160 under vacuum and then the discharge gas 117 is injected to fill the inner space 153. Next, the other of the first and second openings 151 and 152 is closed with the closing means 160. The discharge gas 117 includes mercury (Hg) and an inert gas such as neon (Ne) and argon (Ar).

FIG. 3H is a cross-sectional view illustrating a process of forming first and second external electrodes of an EEFL according to the exemplary embodiment of the present invention.

Subsequently, as shown in FIG. 3H, first and second external electrodes 119 and 120 are formed on an outer surface of the tube in the first and second electrode regions “ER1” and “ER2”, respectively. Further, the first and second electrodes 119 and 120 may have cap shapes and cover both closing means 160 closing the first and second openings 151 and 152.

To form the external electrodes 119 and 120, an electroless plating method may be used. For example, a solution of metal ions is supplied with electrons from a reducing agent and thus is reduced, thereby densely forming the external electrodes 119 and 120 on the outer surface of the tube 111 in the electrode regions “ER1” and “ER2”. The electroless plating method is used for a non-metallic material as well as a metal. Further, to form the external electrodes 119 and 120, a metal tape may be adhered to the outer surface of the tube 111. The external electrodes 119 and 120 may be made of a low resistance conductive material including aluminum (Al), silver (Ag) and copper (Cu).

Through the above explained processes, the EEFL of the exemplary embodiment is fabricated. The EEFL supplies light emitted from the phosphor layer 113 to non-luminous type flat panel displays. In more detail, the discharge gas collides with electrons generated near the electrode regions “ER1” and “ER2”, thereby exciting the discharge gas. Then, the exited electrons return to a stable state so that ultraviolet light is radiated. The ultraviolet light excites the phosphor material, and the excited phosphor material returns to a stable state so that visible light is emitted.

The phosphor layer 113 of the EEFL is formed in the fluorescent region “FR”. If the phosphor layer 113 is also formed in the electrode regions “ER1” and “ER2”, deterioration of the phosphor layer, such as a yellow color change, is caused by ions and electrons accelerated due to high voltages in the electrode regions “ER1” and “ER2” where the external electrodes 119 and 120 are present. Accordingly, the phosphor layer 113 is not formed in the second electrode region “ER2” with a forming process of the phosphor layer 113 using the capillary phenomenon, as shown in FIG. 3B. Further, the portion of the phosphor layer 113 in the first electrode region “ER1” is removed, as shown in FIG. 3D.

The protection layer 115 of the EEFL covers the first and second electrode regions “ER1” and “ER2”. Accordingly, the protection layer 115 protects impurities in the tube 111 from being emitted into the inner space 153.

Further, the protection layer 115 may be made of a material having a high second electron emission coefficient (y). The second electron emission coefficient (y) is the quantity of electrons emitted from a surface of the protection layer 115 in the electrode regions “ER1” “and” “ER2” by collision of accelerated ions with the protection layer 115 in the electrode regions “ER1” and “ER2”. Accordingly, when the second electron emission coefficient (y) increases, electrons emitted in the electrode regions “ER1” and “ER2” increase, and thus a driving voltage for the EEFL can be reduced.

Table 1 shows the second electron emission coefficients of the protection materials accordingly to the exemplary embodiment of the present invention.

TABLE 1

| Protection | Second electron |
|---|---|
| material | emission coefficient (γ) |
| MgO(poly | 0.3˜0.6 |
| crystal) | |
| MgO(single | 0.75 |
| crystal) | |
| MgF₂ | 0.5˜0.6 |
| ITO | 0.15 |
| Y₂O₃ | 0.3 |
| LiF | 0.6 |
| CaF₂ | 0.6 |

In particular, among the protection materials of Table 1, magnesium oxide (MgO) or calcium fluoride (CaF₂) has a high sputtering-resistance against ions. Accordingly, when the protection layer 115 is made of magnesium oxide (MgO) or calcium fluoride (CaF₂), sputtering of the tube 111 in the electrode regions “ER1” and “ER2” can be greatly reduced because the tube 111 in the electrode regions “ER1” and “ER2” is covered by the protection layer 115. Therefore, damage to the tube by ions can be reduced greatly.

In the above explained exemplary embodiment of the present invention, the phosphor layer is formed in the fluorescent region prior to forming the protection layer, and the protection layer covers the entire inner surface of the tube having the phosphor layer. Accordingly, deterioration of the phosphor layer can be improved, the driving voltage of the EEFL can be reduced effectively. Further, the damage to the tube can be reduced greatly. As a result, lifetime and reliability of the EEFL can be improved.

It will be apparent to those skilled in the art that various modifications and variations can be made in the external electrode fluorescent lamp and the method of fabricating the external electrode fluorescent lamp without departing from the spirit or scope of the invention. Thus, it is intended that the present invention cover the modifications and variations of this invention provided they come within the scope of the appended claims and their equivalents.

What is claimed is:

1. An external electrode fluorescent lamp, comprising:
a tube having an electrode region at end regions, and a fluorescent region between the end regions;
a discharge gas filling an inner space of the tube;
a phosphor layer contacting an inner surface of the tube in the fluorescent region;
a protection layer covering the phosphor layer; and
external electrodes on an outer surface of the tube in the electrode regions.

2. The lamp according to claim 1, wherein the protection layer further contacts the inner surface of the tube in the electrode regions.

3. The lamp according to claim 1, wherein the protection layer comprises at least one of magnesium oxide (MgO), magnesium fluoride (MgF₂), indium-tin-oxide (ITO), yttrium oxide (Y₂O₃), lithium fluoride (LiF), or calcium fluoride (CaF₂).

4. The lamp according to claim 1, wherein the tube comprises glass.

5. The lamp according to claim 1, further comprising closing means closing ends of the tube.

6. The lamp according to claim 1, wherein the discharge gas comprises at least one of mercury (Hg), neon (Ne), or argon (Ar).

7. The lamp according to claim 1, wherein the phosphor layer contacts substantially the entire inner surface of the tube in the fluorescent region.

8. A method of fabricating an external electrode fluorescent lamp, the method comprising:
preparing a tube having openings at ends of the tube, the tube having electrode regions at end regions and a fluorescent region between the end regions;
forming a phosphor layer on an inner surface of the tube in the fluorescent region such that the phosphor layer contacts the inner surface of the tube in the fluorescent region;
forming a protection layer covering the phosphor layer;
filling an inner space of the tube with a discharge gas and closing the openings; and
forming external electrodes on an outer surface of the tube in the electrode regions.

9. The method according to claim 8, wherein the protection layer further contacts the inner surface of the tube in the electrode regions.

10. The method according to claim 8, wherein the protection layer comprises at least one of magnesium oxide (MgO), magnesium fluoride (MgF₂), indium-tin-oxide (ITO), yttrium oxide (Y₂O₃), lithium fluoride (LiF), or calcium fluoride (CaF₂).

11. The method according to claim 8, wherein forming the phosphor layer includes:
dipping an open end of the tube into the phosphor material solution, thereby depositing the phosphor material on the inner surface of the tube in the corresponding electrode region and the fluorescent region through a capillary phenomenon;
baking the phosphor material; and
removing the baked phosphor material in the electrode region to form the phosphor layer.

12. The method according to claim 8, wherein forming the protection layer includes:
depositing a protection material on the phosphor layer and the inner surface of the tube; and
baking the protection material to form the protection layer.

13. The method according to claim 8, wherein filling the inner space of the tube with the discharge gas and closing the openings include:
closing at least one of the openings;
filling the inner space of the tube with the discharge gas; and
closing the remaining openings.

14. The method according to claim 8, wherein the tube comprises glass.

15. The method according to claim 8, wherein the discharge gas comprises at least one of mercury (Hg), neon (Ne) or argon (Ar).

16. The method according to claim 8, wherein the phosphor layer contacts substantially the entire inner surface of the tube in the fluorescent region.

17. A method of fabricating an external electrode fluorescent lamp, the method comprising:
forming a phosphor layer directly on an inner surface of a tube in a fluorescent region from an electrode region of the tube to substantially an opposing electrode region of the tube and removing the phosphor layer from the one electrode region;
forming a protection layer covering the phosphor layer;
filling an inner space of the tube with a discharge gas and closing openings of the tube; and
forming external electrodes on an outer surface of the tube in the electrode regions.

18. The method according to claim 17, wherein the protection layer contacts the inner surface of the tube in the electrode regions.

19. The method according to claim 17, wherein forming the phosphor layer includes:
dipping an open end of the tube into the phosphor material solution, thereby depositing the phosphor material on the inner surface of the tube in the one electrode region and the fluorescent region through a capillary phenomenon;
baking the phosphor material; and
removing the baked phosphor material in the electrode region to form the phosphor layer.

20. The method according to claim 17, wherein forming the protection layer includes:
depositing a protection material on the phosphor layer and the inner surface of the tube; and
baking the protection material to form the protection layer.
